(19) United States
(12) Patent Application Publication
(10) Pub. No.: US 2008/0218939 A1
(43) Pub. Date: Sep. 11, 2008

(54) Nanowire supercapacitor electrode

(76) Inventors: Matthew S. Marcus, Plymouth, MN (US); Yuandong Gu, Plymouth, MN (US)

Correspondence Address: Kris T. Fredrick, Esq.;Patent Services, Honeywell International Inc., 101 Columbia Road, Morristown, NJ, 07962, US

(21) Appl. No.: 11/716,413

(22) Filed: Mar. 9, 2007

(51) Int. Cl. H01G 9/035; B05D 5/12; H01G 9/04

(52) U.S. Cl. 361/505; 361/500; 361/503; 427/123; 427/125

(57) ABSTRACT

A nanowire super-capacitor electrode for storing electrical energy. The electrode is formed by anodizing a porous membrane having a uniform pore size and diameter, depositing a metal layer on the membrane back, electroplate metal through the pores of the membrane, dissolving the porous membrane. The formed nanowire electrode is placed in an electrolyte to integrate said nanowire into an electrolytic capacitor.

### FIELD OF THE INVENTION

The present invention relates to a method for creating an electrode for use in super-capacitor applications. More particularly, the invention relates to a device using an electrode that contains a plurality of vertically aligned metallic nanowires to achieve a large capacitance for use in electronic applications, such as filters and energy storing devices.

### BACKGROUND OF THE INVENTION

Capacitors are ubiquitous, finding function in a wide variety of applications including electronic filters and energy storage. Of particular interest are super-capacitors, which posses a larger energy density compared to tradition capacitors. Large energy densities enable the ability to either: (1) provide a modest capacitance in a miniaturized device package; (2) provide an enormous capacitance in a standard form factor.

The electronics industry can significantly benefit from the use of a low-cost method for creating super-capacitors. More specifically, the micro-chip industry is always looking to accomplish a function using less of the space on the chip, thus making more space available for additional functions and features. Furthermore, energy storage applications can benefit from relatively high power densities with a significant energy density offered by super-capacitors.

Typically, super-capacitors are electrolytic capacitors that include a high surface area electrode immersed in a liquid electrolyte. Both the high surface area of the electrode and the short distance of the double-layer of the electrolyte provide a large capacitance.

The majority of existing super-capacitor technology uses carbon-based electrode materials. The carbon-based materials increase the effective surface area of the electrode. Typically, these carbon-based super-capacitors have a disordered array of nano-material on an electrode which hinders ion transport, and therefore decreases power density. The decreased power density is a result of the long path needed to deliver and extract charge (ions) to the electrode from the solution. In addition to inefficient ion transport, the disordered pore structure also prohibits the electrolyte from penetrating into the entire pore structures, thereby limiting the device's capacitance. Furthermore, state of the art carbon-based super-capacitor electrodes also suffer from poor contact resistance at the carbon-metal electrode interface which limits the device's overall power density.

A nanowire has a width dimension on the order of 10⁻⁹-10⁻⁷ meters or one-one hundred nanometers. A variety of nanowires exist, such as metallic, semi-conducting and insulating. Nanowires are artificial materials and are created by suspension, deposition or synthesizing from the materials from which they are made.

Commercial use of nanowires has not yet been achieved to any significant degree. One drawback to nanowire technology is that traditional nanostructure synthesis methods often require expensive vacuum deposition or high temperature methods. The high cost and high temperature processes can prohibit high volume synthesis and integration of the nanostructures into commercially viable devices.

Nanostructured electrodes that posses vertically aligned metal wires have the potential to make a huge impact on the performance of capacitors. The intrinsically large surface-to-volume ratio that nanowires possess provides a performance enhancement where a very large capacitance may be achieved in a small package. Essentially, a small amount of nanowires on an electrode provides an enormous amount of surface area which yields a large capacitance. Additionally, the vertically aligned wires create an ordered pore structure that can allow better electrolyte-electrode coverage and ion transport compared to state of the art super-capacitor technology.

It would be of advantage in the art if a device could be provided that would allow use of nanowires in storing electrical energy as a capacitor or energy storage device.

Yet another advantage would be if the device could be made simply and economically without expensive vacuum deposition and high temperature methods.

It would be another advance in the art if the device would use nanowire configurations to create a large capacitance in a small physical footprint.

Other advantages will appear hereinafter.

### SUMMARY OF THF INVENTION

It has now been discovered that the above and other advantages of the present invention may be obtained in the following manner. Specifically, the present invention provides a nanowire supercapacitor electrode for storing electrical energy.

The electrode is synthesized using a porous membrane formed by an anodization process or other pore forming process, having a uniform pore size and diameter. The membrane should be soluble in solvents that do not affect the formed nanowire. The preferred porous membrane can be alumina and the pore diameter is selected to fit the specific application, but can range down to about 10 nm.

A metal layer is deposited on the membrane back to form a conductor for the electrode. Thereafter, a metal is electroplated through the pores of the membrane to form a nanowire structure against the conductor, such that a large plurality of nanowires extend through the porous membrane. Because the pores are uniform in size and diameter, the nanowire components extend throughout the membrane and have a high amount of surface area. Furthermore, the uniform straight pores create structures where liquid electrolytes can easily penetrate, and efficient ion transport can occur.

The anodized membrane can then be dissolved after the wires have been electrodeposited leaving a well ordered nanowire electrode structure. Sodium hydroxide has been found to be effective in disengaging an alumina membrane from the electrode structure.

The entire nanowire electrode can then be immersed in an electrolyte solution, forming a nanowire super-capacitor. A preferred liquid electrolyte is a high molar concentration organic conductor.

### BRIEF DESCRIPTION OF THE DRAWINGS

For a more complete understanding of the invention, reference is hereby made to the drawings, wherein like numbers refer to like elements, and in which:

FIG. 1 is a four part schematic drawing showing the steps used in making the preferred embodiment of this invention; and

FIG. 2 is a graphical display of the capacitive enhancements compared to controlled planar electrodes as function of frequency.

### DETAILED DESCRIPTION OF THE PREFERRED EMBODIMENT

Self ordered porous membranes, such as anodized alumina templates, offer the ability to synthesize electrodes covered with a controlled array of metal nanowires for use as a high surface area structure in electrolytic capacitor applications. Membrane-based synthesis offers the ability to solve a critical issue in the performance of electrolytic nano-enabled capacitors. More specifically, nanostructured electrodes in capacitor applications often suffer from the inability of the electrolyte to interact with all of the nanostructure surface area yielding a reduced capacitance. This is often a result of the poor control of geometry and architecture of the nanostructures during the synthesis of the electrode. In contrast to existing nano-material synthesis routes, porous membranes have the ability to create controllable electrode geometries and architectures of vertically aligned nanowires in a Process Lab-compatible process. By using membrane-based synthesis, the geometry and architecture of the electrode may be controlled, and therefore the optimum nanowire structures may be synthesized to take full advantage of the nano-electrode's surface area.

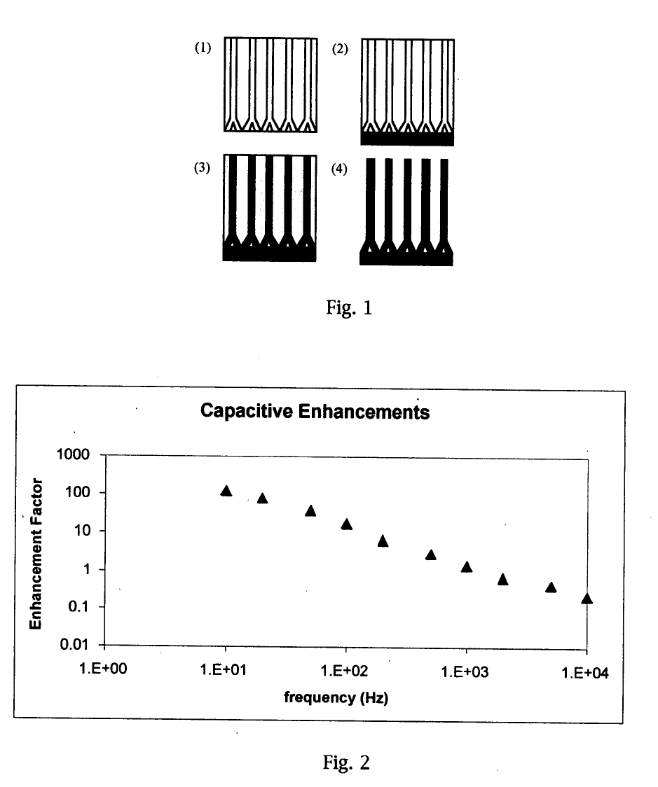

The metal wires may be synthesized by simply electroplating through the membrane, such that the pattern of the anodized porous structure will transfer to the nanowire electrode. As shown in FIG. 1, (1) illustrates an anodized alumina membrane and (2) illustrates the deposit of metal layer on the back of the membrane. (3) illustrates the step of electroplating metal through the pores of the membrane, followed by (4) removal of the membrane by dissolving the membrane, leaving the wire structure shown.

The anodized membrane that has been dissolved after the wires have been electrodeposited leaves a well ordered nanowire electrode structure. The entire nanowire electrode can then be immersed in an electrolyte solution, forming a nanowire super-capacitor.

Two preferred membranes are made from alumina and silica. A preferred alumina membrane is manufactured by Whatman Inc., which has an office in Florham Park, N.J., and produces this alumina membrane under the trade name Anopore®. The pore size ranges from about 0.02 μm to about 0.2 μm. The material has a precise, non-deformable honeycomb pore structure with no lateral crossover between individual pores, so that when the pores are filled, a large plurality of individual wires are formed as nanowires.

One preferred electrolyte contains an ionic liquid in an organic solvent. Two salts that are preferred electrolyte materials are tetraethylammonium tetrafluoroborate salt and tetraethylammonium tetrafluoroborate salt, each of which may be dissolved in an organic solvent. These salts may also be combined with the ionic liquid. Alternatively, the electrolyte may be in an aqueous form.

In a laboratory setting a supercapacitor electrode was prepared by the following steps:
1. Sputter coat back of a commercial alumina (Whatman Anopore) membrane with metal (gold);
2. Coat back of membrane with adhesive conductive tape (copper)
3. Electroplate metal (nickel) through commercial membrane;
4. Place membrane in 6 M NaOH to initiate membrane removal. Slight agitation can assist membrane removal.
5. Vortex membrane for ˜1 min.

The resulting structure had a large plurality of nickel nanowires with ˜300 nm diameter.

These nanowire electrodes were integrated into electrolytic capacitors using 0.1 M NaCl as the electrolyte. As shown in FIG. 2, the nanowires offer a factor of 100× enhancement at low frequency operation compared to a controlled planar electrode. Capacitive enhancements are compared to controlled planar electrodes as function of frequency.

The nanowires of this invention provide large surface to volume ratio allowing large capacitance using a small amount of material. Vertically aligned nanowires allow higher power density compared to carbon-based technology due to easy ion transport and should increase the amount of electrode in direct contact with an electrolyte. The process is process-lab compatible allowing easy integration into MEMS/chip-scale sensors, and it is intended that the supercapacitor electrodes of this invention will be used in a variety of micro-chip applications where supercapacitors perform functions as desired.

While particular embodiments of the present invention have been illustrated and described, it is not intended to limit the invention, except as defined by the following claims.

1. A method of making a nanowire electrode, comprising the steps of:
forming a porous membrane having pores of a uniform pore size and diameter, said membrane having a front and a back;
coating a metal layer on said back of said membrane;
electroplating a metal through said pores of the membrane; and
dissolving said porous membrane to leave said nanowire attached to an electrode structure.

2. The method of claim 1, wherein said metal layer formed on said back is gold.

3. The method of claim 2, wherein said electroplated metal is gold.

4. The method of claim 1, wherein said porous membrane is selected from the group consisting of alumina and silica.

5. The method of claim 1, wherein said pore size ranges from about 0.02 μm to about 0.2 μm.

6. The method of claim 1, which further includes the step of contacting said nanowire with an electrolyte to thereby form a supercapacitor electrode for storing electrical energy.

7. A supercapacitor electrode for storing electrical energy, comprising:
a vertically aligned nanowire electrode and an electolyte deposited thereon;
said nanowire electrode having been formed from a porous membrane having pores of a uniform pore size and diameter, said membrane having a front and a back;
said membrane having a metal layer on said back of said membrane;
said membrane having a metal electroplated through said pores of the membrane; and
said porous membrane thereafter having been dissolved to form a membrane-free nanowire;
whereby adding an electrolyte to said membrane-free nanowire forms said super-capacitor electrode.

8. The device of claim 7 wherein said electrolyte is in an aqueous form.

9. The device of claim 7 wherein said electrolyte contains a salt in an organic solvent.

10. The device of claim 7, wherein said electrolyte is tetraethylammonium tetrafluoroborate salt in an organic solvent.

11. The device of claim 7, wherein said electrolyte is triethymethyllammonium tetrafluoroborate salt in an organic solvent.

12. The device of claim 7, wherein said electrolyte is an ionic liquid.

13. The device of claim 7, wherein said electrolyte contains an ionic liquid in an organic solvent.

14. The device of claim 7, wherein said electrolyte contains a mixture of an ionic liquid and tetraethylammonium tetrafluoroborate.

15. 11. The device of claim 7, wherein said electrolyte electrolyte contains a mixture of an ionic liquid and triethymethyllammonium tetrafluoroborate salt.

16. The device of claim 7, wherein said metal layer formed on said back and said electroplated metal are gold.

17. The device of claim 7, wherein said porous membrane is selected from the group consisting of alumina and silica.

18. The device of claim 7, wherein said pore size ranges from about 0.02 μm to about 0.2 μm.

19. The device of claim 7, wherein said porous membrane pores extend vertically from one end thereof.

20. The device of claim 7, which further includes said electrode being bonded to a micro-chip for electrical contact therewith.
